(19) United States
(12) Patent Application Publication
(10) Pub. No.: US 2020/0055244 A1
(43) Pub. Date: Feb. 20, 2020

(54) METHOD OF FORMING THREE-DIMENTIONAL OBJECT

(71) Applicant: Jingjun WU, Zhejiang (CN)

(72) Inventor: Jingjun WU, Zhejiang (CN)

(21) Appl. No.: 16/161,092

(22) Filed: Oct. 16, 2018

(30) Foreign Application Priority Data
Aug. 15, 2018 (CN) 201810928637.5

(51) Int. Cl. B29C 64/314; B29C 64/135; B33Y 10/00; B33Y 40/00

(52) U.S. Cl. CPC B29C 64/314; B33Y 40/00; B33Y 10/00; B29C 64/135

(57) ABSTRACT

This invention relates to a method of forming 3D object, comprising the steps of a photosensitive resin in a resin tank is irradiated by a projection device, and cured by photocuring on a sunken platform for cured layer formation; the photosensitive resin is pretreated prior to photocuring to reduce the dissolved oxygen content in the resin. This method eliminated the converting process from formed solid-air interface to liquid resin-air interface, greatly improving the 3D forming efficiency with simple device construction.

### CROSS-REFERENCE TO RELATED APPLICATION

This application claims the priority benefit of China Application No. 201810928637.5, filed on Aug. 15, 2018. The entirety of the above-mentioned patent application is hereby incorporated by reference herein and made a part of this specification

### BACKGROUND OF THE INVENTION

### 1. Field of the Invention

This invention relates to rapid molding technology, specifically relates to a method of forming three-dimensional object.

### 2. Description of Related Art

Photocuring 3D printing, possessing the highest precision among all the printing technologies, uses liquid photosensitive resin as the printing material, and solidifies by photocuring under specific wavelength light exposure. Photocuring 3D printing primarily comes in two types of technologies: stereolithography (SLA) and digital light processing (DLP). Specifically, DLP photocuring 3D printing adopts planar digital masks and possesses a relatively higher printing speed. However, when a layer is exposed to light, it has to wait for resin backfilling and replenishing (the time taken for resin replenishing is usually longer than the photocuring duration), therefore, the absolute speed of DLP photocuring, which is typically at 2-4 cm/h is not adequately high.

The American Carbon Company has developed a Continuous Liquid Interface Production (CLIP) technology, which utilizes the oxygen inhibition of the photosensitive resin to form an uncured dead zone between the resin tank and the cured layer, hence greatly reducing the resin replenishing time, improving the printing speed to 300 mm/h.

CLIP technology adopts a bottom-up printing mechanism, where resin is cured in the bottom of the resin tank by a light source from below and the platform for cured layer formation is raised out of the resin tank, for which the printed parts cannot be too heavy, because the part is hung under the tray by the adhesive force of the cured resin only. Besides, CLIP requires precision oxygen regulation and complex mechanical structure.

Some photocuring 3D printers, such as those manufactured by Prismlab China Ltd., adopt a top-down printing mechanism, where resin is cured by a light source above the resin tank and the platform for cured layer formation is lowered down into the resin tank. These printers are favorable to print large size parts. The projector is above the resin tank, and the liquid photosensitive resin is cured to form a solid-air interface as a result of free radical polymerization under the irradiation of ultraviolet or visible light. When the platform lowers down, the surrounding liquid photosensitive resins flow onto the solid surface, to reform a new liquid resin-air interface, and preparing for the polymerization of next slice layer. Replenishing of the liquid resin turns the formed solid-air interface into liquid resin-air interface. This process involves the leveling, moisturizing and spreading of the liquid at the solid-air interface, and a scraper is typically required for enhancing the leveling. The leveling time is generally longer than the exposure duration for polymerization. The 3D constructing process of exposure—lowering—leveling—exposure comes in low speed and low efficiency.

In addition, patent document CN 105437547 A disclosed a printing platform utilizing the top-down printing mechanism. By applying oxygen onto the liquid interface of the resin, a “dead zone” is formed, which is similar to that of the CLIP technology. The major disadvantage of such a device is that during 3D printing process, oxygen needs to be added continuously in an enclosed space of the resin tank to maintain oxygen molecule balance, as a result, the construction of such a device is complex and not easy to control and achieve.

### SUMMARY OF THE INVENTION

The purpose of this invention is to provide a method of forming 3D object to overcome the shortcomings of the prior art by eliminating the converting process of solid-air interface to liquid resin-air interface. This method greatly improves the manufacturing efficiency using a simple device construction.

The technical solution provided by this invention is as follows:

A method of forming 3D object: the photosensitive resin in the resin tank is irradiated by a projection device, and solidifies by performing photocuring on a sunken platform for cured layer formation which is lowered down to the resin tank; the said photosensitive resin is pretreated prior to the photocuring to reduce the dissolved oxygen content in the photosensitive resin.

In this invention, before photocuring, the photosensitive resin is subjected to pretreatment to control the dissolved oxygen content in the liquid photosensitive resin, so as to increase the oxygen concentration gradient between the liquid photosensitive resin and the surrounding air. When a projection device irradiates the photosensitive resin in the resin tank, on one hand, the cured layer will be formed on the platform; on the other hand, the liquid photosensitive resin close to the air interface will form an uncured liquid layer due to the “oxygen inhibition effect”, hence a stable liquid photosensitive resin-air interface is continuously provided during the whole process of forming 3D object. This method eliminates the converting process of converting the photosensitive resin from solid-air interface to liquid resin-air interface, and greatly improves the whole process of forming 3D object in the steps of exposure—lowering—leveling—exposure from lower to higher efficiency. If the photosensitive resin is not subjected to the pretreatment, when an uncured liquid resin layer is formed on the surface, the liquid resin in the resin tank cannot be cured as well due to the existence of dissolved oxygen in the resin.

The method in this invention comprises the following steps:

1) the photosensitive resin is pretreated prior to photocuring to reduce the dissolved oxygen content in the said photosensitive resin;

2) the photosensitive resin in the resin tank is irradiated by the projection device disposed above the tank; the photosensitive resin is photocured into a solid layer on the sunken platform for cured layer formation which is lowered down to the resin tank, an uncured liquid layer is formed between the cured layer and the air;

3) the sunken platform drives the formed cured layer downward;

4) repeat steps 2) and 3) to complete the formation of 3D object.

The sunken platform in this invention can be lowered at a constant speed or adopted to an intermittent lowering step of irradiating—lowering—irradiating.

The projection device in this invention comprises LCD projection, DLP projection, SXRD projection or LCOS projection.

Preferably, the thickness of the uncured liquid resin layer is 10-200 microns. Further preferably, the thickness of the uncured liquid resin layer is 10-100 microns.

Preferably, the temperature for the photosensitive resin in step 2) is controlled to 30-50° C., further preferably is controlled to 35-45° C. By controlling the temperature of the photosensitive resin, the dissolved oxygen content in the photosensitive resin can be maintained to form a constant oxygen content gradient between the photosensitive resin and the air.

As an optimum option, the pretreatment is a bubbling treatment of the photosensitive resin using oxygen-free gas. The oxygen-free gas is oxygen-free mixed gas or inert gas.

As an optimum option, the pretreatment in this invention is a heat treatment of the photosensitive resin.

As an optimum option, the pretreatment in this invention comprises a bubbling treatment and a heat treatment of the photosensitive resin using oxygen-free gas.

Preferably, the oxygen-free gas comprises one or more of nitrogen, argon and helium. Bubble using nitrogen, argon and helium etc. can reduce the dissolved oxygen content of the photosensitive resin.

Preferably, the temperature of the heat treatment is 50-100° C. Further preferably, is 50-70° C.

Preferably, the viscosity of the photosensitive resin is controlled to be 500 mpa·s or lower than 500 mpa·s.

The photosensitive resin in this invention includes acrylate and a photoinitiator, wherein the acrylate is not limited to acrylic ester only, but also includes methacrylate.

Preferably, the acrylate can be selected from one or more of acryloyl morpholine, isobornyl acrylate, metacrylic isobornyl acrylate, hexamethylene diacrylate (HDDA), trimethylolpropane triacrylate, poly(ethyleneglycol)dimethacrylate, bisphenol A ethoxylatedimethacrylate, tricyclo decanedimethanol diacrylate; preferably, the photoinitiator can be selected from Irgacure 819 or diphenyl(2,4,6-trimethylbenzoyl)phosphine oxide (TPO).

Comparing to the prior art, the advantageous effects of the invention of the present application are as follows:

(1) In this invention, by controlling the dissolved oxygen content of the liquid photosensitive resin, a stable uncured liquid resin layer is formed on the surface during the curing process of the photosensitive resin, hence a stable liquid resin-air interface is constantly formed during the whole forming process, which greatly improves the efficiency of resin leveling and replenishing, eliminating the step of forced leveling and replenishing by using a scraper system of a conventional sunken platform mechanism in the technology of forming 3D object.

(2) The method of this invention primarily subjected to a pretreatment of the liquid photosensitive resin without modifying the design of the device for forming 3D object, and hence no complex construction of the device is required.

These and other objectives of the present invention will no doubt become obvious to those of ordinary skill in the art after reading the following detailed description of the preferred embodiment that is illustrated in the drawing and figure.

### BRIEF DESCRIPTION OF THE DRAWINGS

The accompanying drawing is included to provide a further understanding of the invention, and are incorporated in and constitute a part of this specification. The drawing illustrates embodiment of the invention and, together with the description, serve to explain the principles of the invention.

FIG. 1 is an illustration of the device used in this invention.

1 Projection device; 2 Forming platform; 3 Liquid resin; 4 Resin tank; 5 Air-liquid resin interface; 6 Uncured liquid resin layer; 7 Cured resin layer; 8 Previously formed object.

### DESCRIPTION OF THE EMBODIMENTS

Below is further detailed description of this invention in combination with embodiments.

The 3D forming device adopted in this invention comprises a resin tank, a platform for cured layer formation and a projection device, which can adopt the conventional top-down printing mechanism of 3D forming device in the prior art.

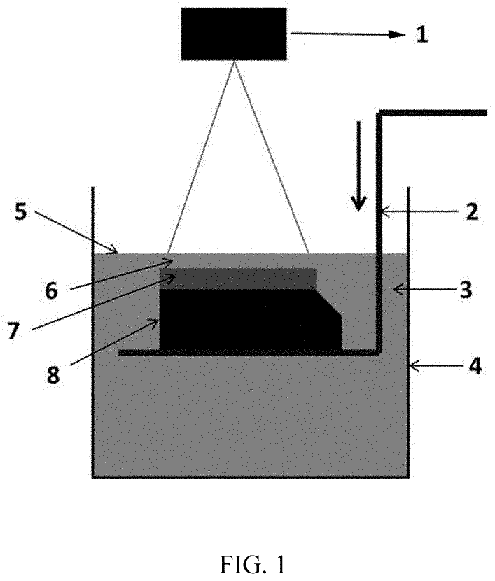

In an embodiment of this invention as shown in FIG. 1, the 3D forming device comprises a resin tank 4, a forming platform 2 and a projection device 1.

Wherein the forming platform 2 is arranged in the resin tank 4, which can be lowered or lifted, the forming platform 2 can adopt constant speed lowering or intermittent lowering. The resin tank 4 is for holding the pretreated liquid photosensitive resin. The projection device 1 is located above the forming platform 2, which irradiates UV or visible light from the upper part of the liquid photosensitive resin. The projection device can be adapted from LCD projection, DLP projection, SXRD projection or LCOS projection.

The photosensitive resin in the resin tank 4 is pretreated prior to photocuring to reduce the dissolved oxygen content in the photosensitive resin; the photosensitive resin includes acrylate and a photoinitiator, of which the viscosity needs to be controlled to be 500 mpa·s or lower than 500 mpa·s. The acrylate can be selected from one or more of acryloyl morpholine, isobornyl acrylate, metacrylic isobornyl acrylate, hexamethylene diacrylate (HDDA), trimethylolpropane triacrylate, poly(ethyleneglycol)dimethacrylate, bisphenol A ethoxylatedimethacrylate, tricyclo decanedimethanol diacrylate; preferably the photoinitiator can be selected from Irgacure 819 or diphenyl(2,4,6-trimethylbenzoyl)phosphine oxide (TPO).

As an embodiment of this invention, a device as shown in FIG. 1 is adopted, the method of forming 3D object comprises the steps as follow:

1) The acrylate and photoinitiator are proportionally mixed to obtain a liquid resin 3, of which the viscosity needs to be controlled to be 500 mpa·s or lower than 500 mpa·s. The liquid resin 3 is pretreated to reduce the dissolved oxygen content in the resin tank. Pretreatment of the liquid resin 3 can be bubbling using oxygen-free gas, heat treatment of the liquid resin 3, or both of the aforementioned treatment methods can be conducted at the same time.

2) Add the liquid resin 3 into the resin tank 4 until the liquid level is above the forming platform 2, UV or visible light is radiated from the upper portion of the projection device 1, the liquid resin 3 is photocured to form a cured layer 7 on the forming platform 2, the uncured liquid resin layer 6 is formed between the cured resin layer 7 and air-liquid resin interface 5.

3) Lowering of the forming platform 2 to drive the cured resin layer 7 downward, which is a previously formed object 8.

4) The projection device 1 continues to irradiate UV or visible light, photocuring continues on the previously formed object 8 to form the cured resin layer 7, and uncured liquid resin layer 6 with a thickness of 10-100 micron is always maintained between the air-liquid resin interface 5 and the cured resin layer 7.

5) Step 4) is repeated continuously until the forming of 3D object is completed.

Below is specific description of this invention.

### Embodiment 1

| | |
|---|---|
| Acryloyl morpholine | 60 g |
| HDDA | 40 g |
| Irgacure 819 | 3 g |
| Methylsilicone oil | 3 g |

Pretreatment method: heat up in oven of 60° C. for 30 minutes, maintain the resin temperature at 40° C. during the printing process. The printing speed is 30 cm/h (slice thickness at 100 microns).

### Comparison Example 1

| | |
|---|---|
| Acryloyl morpholine | 60 g |
| HDDA | 40 g |
| Irgacure 819 | 3 g |

Forced leveling is required, the printing speed is 2 cm/h (slice thickness at 100 microns).

### Embodiment 2

| | |
|---|---|
| Polyethylene glycol 700 diacrylate | 30 g |
| HDDA | 70 g |
| Irgacure 819 | 3 g |

Pretreatment method: bubble for 5 minutes using nitrogen (at 2-3 bubbles/minute), maintain the resin temperature at 40° C. during the printing process, and the printing speed is 40 cm/h (slice thickness at 100 microns).

### Comparison Example 2

| | |
|---|---|
| Polyethylene glycol 700 diacrylate | 30 g |
| HDDA | 70 g |
| Irgacure 819 | 3 g |

Forced leveling is required, the printing speed is 2 cm/h (slice thickness at 100 microns).

### Embodiment 3

| | |
|---|---|
| Acryloyl morpholine | 60 g |
| HDDA | 40 g |
| Irgacure 819 | 3 g |
| Polyethylene glycol | 3 g |

Pretreatment method: bubble for 10 minutes using nitrogen (at 2-3 bubbles/minute), and the printing speed is 30 cm/h (slice thickness at 100 microns).

### Comparison Example 3

| | |
|---|---|
| Acryloyl morpholine | 60 g |
| HDDA | 40 g |
| Irgacure 819 | 3 g |
| Polyethylene glycol | 3 g |

Forced leveling is required, the printing speed is 2 cm/h (slice thickness at 100 microns).

### Embodiment 4

| | |
|---|---|
| Bisphenol A ethoxylatedimethacrylate | 80 g |
| Trimethylolpropane triacrylate | 20 g |
| Irgacure 819 | 3 g |
| Methylsilicone oil | 3 g |

Pretreatment method: bubble for 10 minutes using nitrogen (at 2-3 bubbles/minute), and the printing speed is 20 cm/h (slice thickness at 100 microns).

### Comparison Example 4

| | |
|---|---|
| Bisphenol A ethoxylatedimethacrylate | 80 g |
| Trimethylolpropane triacrylate | 20 g |
| Irgacure 819 | 3 g |
| Methylsilicone oil | 3 g |

Forced leveling is required, the printing speed is 2 cm/h (slice thickness at 100 microns).

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of forming 3D object, comprising: a photosensitive resin in a resin tank is irradiated by a projection device above the resin tank, and cured by photocuring on a sunken platform for cured layer formation; the photosensitive resin is subjected to a pretreatment prior to the photocuring to reduce the dissolved oxygen content in the photosensitive resin.

2. The method according to claim 1, wherein the method comprises the steps of:
1) the photosensitive resin is pretreated prior to the photocuring to reduce the dissolved oxygen content in the photosensitive resin;
2) the photosensitive resin in the resin tank is irradiated by the projection device above the resin tank; the photosensitive resin is photocured into a cured solid resin layer on the sunken platform, an uncured liquid resin layer is formed between the cured solid resin layer and air;
3) the sunken platform drives the cured solid resin layer downward;
4) repeat steps 2) and 3) to complete the forming of 3D object.

3. The method according to claim 2, wherein the uncured liquid resin layer has a thickness of 10-200 microns.

4. The method according to claim 1, wherein the pretreatment is a bubbling treatment of the photosensitive resin using oxygen-free gas.

5. The method according to claim 1, wherein the pretreatment is a heat treatment of the photosensitive resin.

6. The method according to claim 1, wherein the pretreatment is a bubbling treatment and a heat treatment of the photosensitive resin using oxygen-free gas.

7. The method according to claim 4, wherein the oxygen-free gas comprises one or more of nitrogen, argon and helium.

8. The method according to claim 6, wherein the oxygen-free gas comprises one or more of nitrogen, argon and helium.

9. The method according to claim 5, wherein a temperature of the heat treatment is 50-100° C.

10. The method according to claim 6, wherein a temperature of the heat treatment is 50-100° C.

11. The method according to claim 1, wherein a viscosity of the said photosensitive resin is controlled to be 500 mpa·s or lower than 500 mpa·s.

12. The method according to claim 1, wherein the photosensitive resin includes an acrylate and a photoinitiator.
